(19) United States
(12) Patent Application Publication
(10) Pub. No.: US 2009/0271378 A1
(43) Pub. Date: Oct. 29, 2009

(54) POINT TO MULTI-POINT MEDICAL COMMUNICATION MATRIX

(76) Inventor: Jonathon Bradley Witherspoon, Sarasota, FL (US)

Correspondence Address: MICHAEL RIES, 318 PARKER PLACE, OSWEGO, IL, 60543, US

(21) Appl. No.: 12/432,744

(22) Filed: Apr. 29, 2009

Related U.S. Application Data
(60) Provisional application No. 61/048,891, filed on Apr. 29, 2008.

(51) Int. Cl. G06F 17/30

(52) U.S. Cl. 707/3; 707/E17.108

(57) ABSTRACT

A method including at least one processor coupled to a computing device and linked to a plurality of databases on which records are stored for contacting a medical professional by a user of the computing device comprises the steps of: activating a service software program by operating an icon on the computing device to perform a function of locating a medical professional; searching for the medical professional; and providing video consults by telemedicine by establishing communication between said medical professional and said user of the computing device upon locating said medical professional.

This patent claims the benefit of Provisional Application Ser. No. 61/048,891, filed Apr. 29, 2008, the contents of which are incorporated herein by reference in their entirety.

### BACKGROUND OF THE INVENTION

1. Field of the Invention

This invention relates generally to systems and methods for communicating with medical personnel. In particular, this invention relates to communicating with a medical professional who is either known or not known via a preprogrammed or non-programmed device that, when activated by an icon, automatically connects the user to desired persons or devices.

2. Description of the Prior Art

A widely used method employed today to request emergency medical services is to place a voice phone call to an Emergency Response Center by dialing a specified emergency phone number (In the U.S. this is number is “911”), and then the emergency is verbally explained to the person who answers the phone. The emergency phone number that is dialed is different within various regions as well as across various countries.

In the United States, there are thousands of Emergency Response Centers (hereinafter “ERCs” or “ERC” when used in the singular tense) dedicated to handle 911 emergency calls. Some ERCs are equipped with teletype (“TTYP”) devices in order to communicate with persons with certain disabilities. However, TTYP equipment utilizes telephone lines and requires the user to type out details concerning the emergency situation. Based on the needs described by the caller, appropriate emergency services are dispatched to the location where they are needed. According to this system, the emergency services are made available to the calling party in as short a time as possible. This results because most situations require an immediate response. However, having to explain the emergency situation to emergency response personnel over voice communication lines has, to date, remained the only way to access emergency services.

The prior art system of requesting emergency services has a number of disadvantages. A person may not always have access to a voice communication line, or the person calling for emergency services may not know the appropriate number to call. In fact, sometimes a person in need of emergency service may not be able to call for emergency service (911 or some other number) and/or communicate verbally with the emergency operator. This can happen when the person is not near a phone or cannot reach it because of an injury, a disability, or the person is experiencing a medical condition such as a heart attack.

Often a caller to an ERC is unable to quickly give all the necessary information. For example, it may be difficult to describe the location of the emergency. Additionally, the person making the call may not know or have specific information concerning the party in need of emergency assistance (a stranger acting as a Good Samaritan and placing the call on behalf of the person in need); there may be a language problem as the calling person may speak a foreign language.

In many instances, communicating the necessary information can waste precious time, or the communicated information may in fact be incomplete, incorrect, or misunderstood. The current method of calling does not allow the caller to call other parties, for example, contacting a medical professional such as a medical doctor, nurse, pharmacy, etc. known or not known to the caller who needs to be informed of the situation.

### SUMMARY OF THE INVENTION

The present invention provides a one-click solution for contacting a specific medical person who is either known or unknown to the caller. The invention may be used to quickly and automatically provide critical medical information, diagnostics, to emergency services and/or a medical professional via video, including the nature of the emergency, the address and/or location of the emergency. This is accomplished by clicking on an icon on a computing device, a SmartTV screen, TV Set-top Boxes, Smartphones such as the iPhone, Blackberry, Palm, etc, or another communication device which is connected to a number of data bases for connection to a medical professional securely over a wired or wireless encrypted communication link.

This invention is ideally suited for use in public and private areas such as a home, a work environment, at hotels, malls, parking lots, stadiums, etc.

The invention comprises an icon on a computing device, a SmartTV screen, a regular TV using a set-top box, Smartphone, or any other communication device. The icon can be on a computing device and have a specific color or shape.

The computing device has a microprocessor for running the dedicated software of this invention. Preferable computing devices include, PCs, networked (by LAN or WAN) or connected to the internet (including broadband wired and wireless access), laptops, handheld PDAs, etc. Other computing devices can include mobile phones, and other mobile devices such as that are specifically designed for video conferencing.

According to a preferred embodiment of the invention, the icon can be executable in any operating system environment, for example, Windows, Linux, Unix, Palm, Macintosh, etc.

The icon software can contain all the information necessary for prompt and efficient response, including the address and/or location of the user. This would suffice when the system is installed on a public device. When the system is installed on a personal device, the software can also include the name, age, medical information and history of the person likely to be the user of the computing device. Medical information can include, for example, allergies, prescription drugs taken, etc. The software can contain passwords for obtaining confidential medical information about the user from various web sites or other computer systems.

According to one embodiment of the invention, the software may also include a database of important personnel such as doctor(s), nurse, special pharmacy needs, etc.

Alternatively, the dedicated software may direct the response center to a website that contains all the necessary and important emergency response information. According to this embodiment, the emergency response center and/or medical professional is alerted to the website (or it is self alerted) wherein useful information may be found for the emergency situation. The password-protected information can be accessed once the password information is delivered via the file, verbally, SMS (or its equivalent), or other suitable means.

The dedicated software may also automatically set up a chat session and/or video conference with the 911 response center to talk about the emergency and ask for assistance. A chat session and/or video conference can also be set up with a doctor, a nurse, a pharmacist, etc.

The icon may include one or more sub-icons that may have more limited information concerning the emergency, or the person or family in need of assistance.

The present invention can be further utilized in many other situations when one needs to reach out for assistance. Such situations can include non-life threatening medical emergencies. According to the invention, local authorities (hospitals, police, etc.) can be reached directly to provide assistance. These local authorities will now have more timely and complete information that may lead to more effective services.

In addition to sending information to various parties when activated by an end user, the dedicated software can also be configured to provide information to the end user such as, the email address of the user's doctor, the phone number of the user's pharmacist, etc.

The present invention also provides for complete privacy for the exchange of information from the person initiating the contact to the Emergency Response Center (ERC) and/or medical professional through a medical concierge type consult via video (MC). This is done using encryption technology for encryption of the information before it is exchanged. In an embodiment, the ERC and/or MC makes its public keys for encryption available to the public for any information that is sent to the ERC and/or MC. These public keys may be common to all the ERCs and/or MC of a region/country. Thus, only authorized personnel associated with the emergency management system (Emergency Response Center, law-enforcement, and/or MC, etc.) will have access to this information.

As an alternate embodiment or in addition to performing all the other tasks as described in this invention, the dedicated software may also access the website of the ERC and/or MC to fill out the necessary description required to access the emergency services.

The previous paragraphs have outlined the intended feature of the present invention so that those versed in the art may better understand the in depth description of the invention that follows. Additional characteristics of the invention will be delineated hereinafter that forms the subject of the claims of the invention. Those skilled in the art should recognize that they can readily use the idea and specific embodiment as a base for designing or modifying the structures for carrying out the same purposes of the present invention and that such other characteristics do not depart from the spirit and scope of the invention in its broadest form.

### BRIEF DESCRIPTION OF THE DRAWINGS

Other facets, characteristics, and advantages of the present invention will become more fully evident from the following detailed description, the appended claim, and the accompanying drawings in which similar elements are given similar reference numbers.

FIG. 1 shows the various elements of the invention and the communication links between them;

FIG. 2 shows a flow chart of the preferred embodiment of the invention from the perspective of the person initiating operation of an emergency icon; and

FIG. 3 is a flow chart of a computer system for use with the present invention.

### DETAILED DESCRIPTION OF THE INVENTION

Dedicated software is loaded onto a computing device or any device that can support a non-dedicated communication structure—be it a home computing device, automobile computing device, hand held computing device, or publicly displayed computing device available in a public location for public use.

Many automobiles are equipped with computing devices that are used in cases of emergencies such as accidents, auto-theft or attempt thereof. Onstar is one such example that is currently in use. These devices may be programmed to contain the dedicated software or they may remotely execute the software on a home computer.

An icon can be located on the screen or display of a computing device. Clicking or activating the icon causes the dedicated software application to execute. Alternatively, or in addition to an icon, a keyboard and/or a mouse and/or a monitor and/or other places on the computing device may be provided with a button that can initiate the execution of the software application. According to an additional substantiation of the invention, a button for initiating execution of the dedicated software application can be provided on a wearable band.

Icon(s) can also be incorporated into one or more programs running on the computing device at any given time, for example, Internet Explorer, Google Chrome, Microsoft Office, etc. Emergency Icon(s) can also be provided on web sites that a person may have registered with and/or visits frequently, for example, msn.com, cnn.com, or yahoo.com.

When an emergency or non-emergency situation arises, a person may click the icon on the computing device they are using, or in the application he/she is using, or on the website they are visiting. Alternatively, the person may press an activation button at home, office, or other convenient location, or even activate the application by voice command.

The software application can also be executed remotely by using a computer device outside the house connected to the internet, by using a Smartphone or portable device, etc.

According to one substantiation, the dedicated software can be executed by an automobile when its system detects an emergency situation. According to a further embodiment, the dedicated software program may be automatically executed when a computing device on a person detects a serious medical condition such as a heart attack.

Once the dedicated software program is activated, the dedicated software program may contact other computing systems maintained by a doctor, nurse, pharmacist, etc, to automatically upload important information to those systems as well.

According to an embodiment of the invention, a unique URL may be assigned to every phone number or IP address. When the ERC and/or medical professional receive a telephone call or video chat request, it can automatically access the website of the URL that corresponds to the phone number or IP address of the incoming call. According to this embodiment, this web site contains pertinent information about the persons who use the phone number.

Preferred embodiments are URLs of the type where the phone number that is used to place the emergency call is automatically recognized at the emergency response center using the caller ID function and, therefore, the information on the web site can also be automatically displayed there. Alternate embodiments are also possible and are included in the spirit of the invention.

According to a further embodiment of the invention, the Emergency Software may initiate a chat/video session with the 911 ERC to communicate the nature of the emergency and seek assistance. Such sessions can also be opened to communicate with other persons—for example, a doctor, a pharmacist, or a nurse, all of whom can be dispatched to assist in the emergency. The dedicated software program can include translation software for providing voice and text translations of information sent and received.

Not all parts of the system and method of this invention may be available at all times as different parts require accessibility to different computing environments. For example, if the computing system is a stand-alone system, it may only provide information and guidance to the person seeking emergency assistance. This will help the caller to communicate more effectively with the 911 operator. Therefore, even if a 911 phone call is made, the software program can still be used with or without internet components in getting emergency assistance.

For computing devices that are connected via a LAN or for computing devices that share resources, any emergency initiated by one computing device, may put all the other computing devices into an emergency mode.

For mobile devices, the dedicated software/service can be configured to initiate a call or use a short message service to communicate an emergency or video conference. The mobile device may further trigger emails and transfer of system response file. The software will automatically include the location details in the information communicated.

For automobiles, any service that can determine location (GPS) can be combined with the computing or similar device (that may also be a part of the automobile itself) to call the emergency response center. For travel by automobiles and airplanes, the system can include information such as the medication on board and how it may be retrieved. As soon as a person is mobile and moves to a new location, the communication system (be it a wireless system such as GSM or wireless local area network, or a local area network or some other equivalent system), can automatically update the person (including his/her equipment) with emergency information related to the situation.

According to an elected embodiment of the invention, all information (icons, text) can be speech enabled. Text-to-speech and speech-to-text systems may also be used to facilitate the emergency procedures.

Even when a phone call can be placed to the emergency operator, the system can still help in many ways, for example, the information can be read over the phone from the emergency software program on the computer.

As a part of the process of registration for travel and entertainment services (for example, cruises, air-travel, train travel, hotels, camping grounds, amusement parks), the computing devices of the person and the establishment can exchange information that is used in emergency situations. For example, the computing device of a person can communicate medical information to the computing system of the cruise operator to use if an emergency occurs during the cruise. The computing system of the amusement park operator can inform the computing device of the person's critical phone numbers to call in case an emergency arises on the park premises.

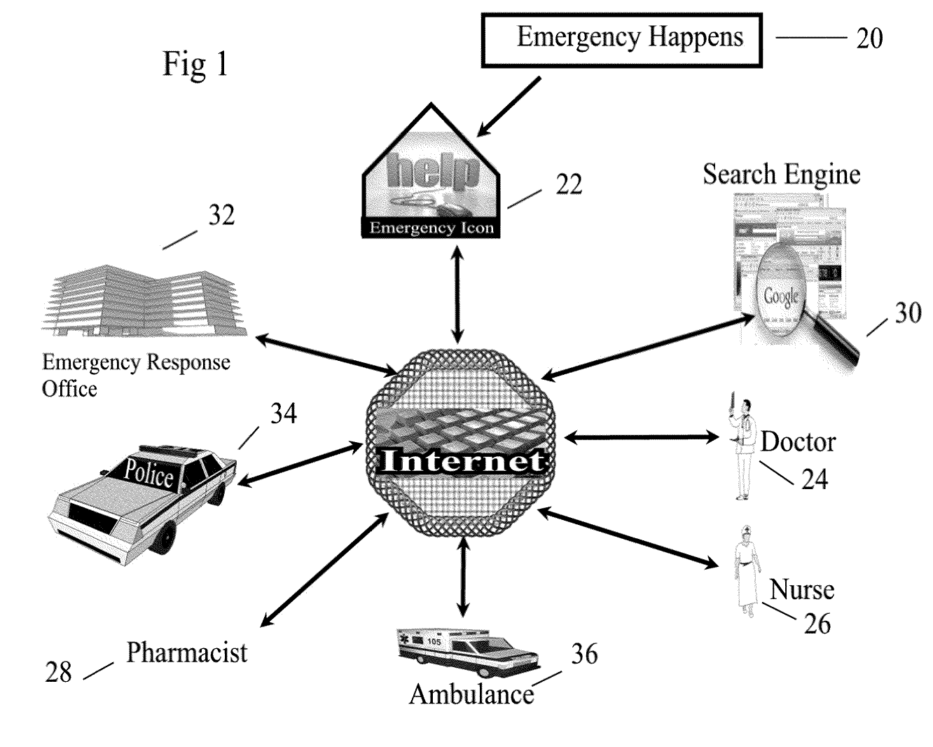

Referring to FIG. 1, upon the occurrence of an emergency 20 such as a need for a person to contact his/her doctor, the person clicks or activates an icon or a button on a computing device 22. Depending on how the computing device is programmed, a signal is sent over the internet to one or more doctors 24, nurse 26, pharmacist 28, to a search engine 30 to search for and identify a specific individual who may not be known by the user such as a doctor, to an emergency response center 32, a local police department 34, a hospital requesting an ambulance 36, etc.

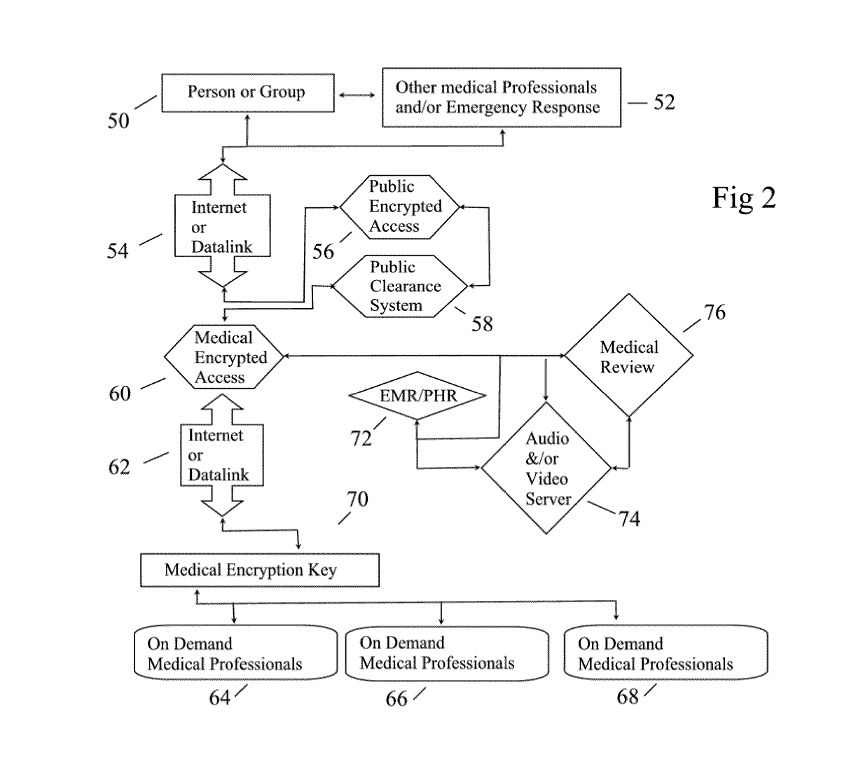

Referring to FIG. 2, there is shown a flow chart of the preferred embodiment of the invention from the perspective of a person initiating the operation of an icon.

With the invention disclosed, a person or group (point) activates the system by selecting to speak to a medical professional. In some cases, hardware monitoring can activate the system if the information that is detected is not within normal range.

When the system is activated by a user pressing or activating an icon, or by hardware monitoring the system, the system then searches and finds the fastest route to a medical professional.

The medical professional(s) then answers their video or audio call and an EMR/PHR system launches on the medical professionals side so that they may take proper medical information that then may be stored, or shared with the proper people later for review.

At block 50, a person of group of persons initiates operation of the program by clicking an icon requesting a response from a known or an unknown medical doctor. In response to activation of the program, other medical professional and/or emergency personnel respond, block 52. The request for a doctor is transmitted via the internet or a data link, block 54, is encrypted with a public key, block 56, and passes to public clearance system, block 58. Within public clearance system, block 58, there is a check to see if the person accessing a medical professional has membership, insurance, or needs to self-pay via pay-pal, credit card, or check before having access to a medical consultation. The output of block 58 is sent to block 60 where it is again encrypted. After being encrypted at block 60, the signal is transmitted via the internet or a data link, block 62. Prior to being received by On-demand medical professionals, blocks 64, 66, 68, the signal is provided with a medical encryption key, block 70. At least one of the on-demand medical professionals, upon receiving a signal from the person at block 50, will respond to the request from block 50.

Returning to block 60, the encrypted signal is sent to the EMR/PHR, block 72, an audio and/or video server, block 74, and to block 76 where the medical records of the person at block 50 are kept and accessed.

Using the invention disclosed, a person, or a group can be anywhere on the earth and still be connected to a medical professional whom they know or do not know, such as a Doctor, Nurse, Pharmacist, etc., by simply selecting a dedicated icon on a computer screen, tv screen, Smartphone, pda, or any other communication device, and be connected to any on-demand medical professional securely over a wired or wireless high-encrypted/high speed national or international communication matrix.

In operation, a person or group (point) can be in front of a computer, TV, iphone, or other communication device and request a video or chat call to an on-demand doctor by selecting an icon on a web page or with a special program screen. The system (server) then determines which type of medical professional to connect to and who is available to discuss any medical information over a high speed and high encrypted communication matrix. The multi-point part of the system is for finding a medical professional whom the point knows or does not know, and diverts the video and/or audio conference to the correct medical professional without having the person, or group (point) needing to find the medical professional themselves—The system finds a medical professional for them. There is no need to search or leave messages for a medical professional to call back. The video and/or audio call over the computer, TV, iphone, or other communication device is diverted to a doctor who has an on-demand status. The system can connect any point to any one of the multi-points in the world so any one within a multi-point matrix can view, discuss, or otherwise identify a single person or group (point) of people. The medical professional (multi-point), when connected from the point can launch a digital EMR/PHR system so anything that is discussed can be stored by the medical professional so that the medical information can be referred to at a later date. The point side of the system can also be connected to any wired or wireless medical device so any health information can be collected and simultaneously transferred to any of the on demand medical professionals in the multi-point matrix for instant review.

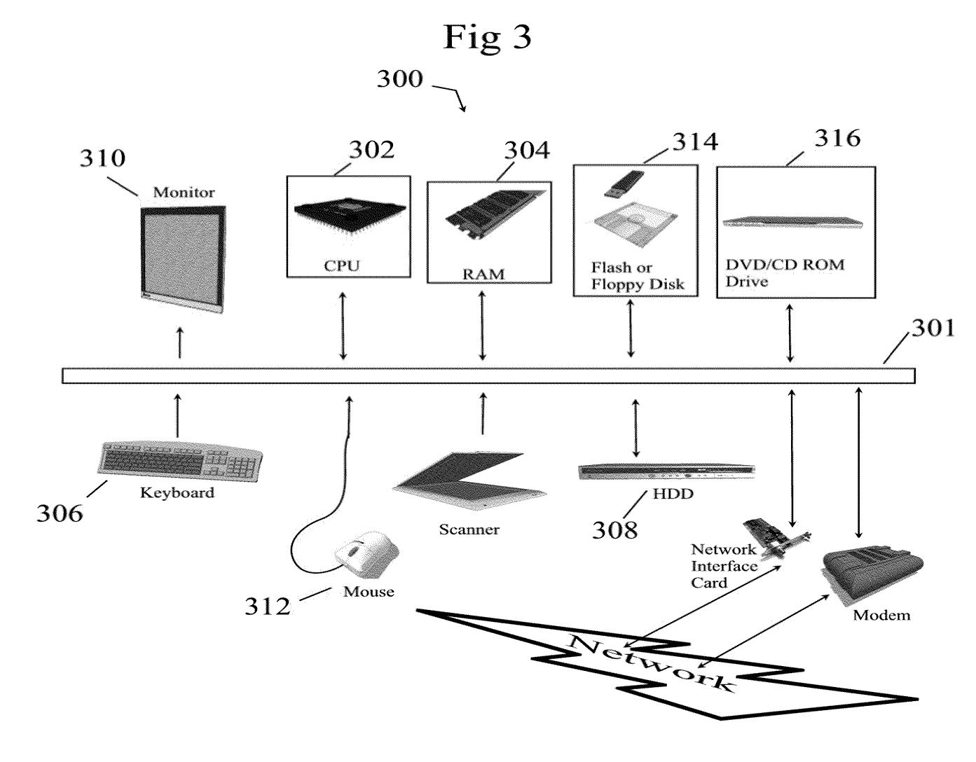

The present invention can be used on any properly configured general purpose computer system, such as the system shown in FIG. 3. Such a computer system 300 includes a processing unit (CPU) 302 connected by a BUS 301 to a random access memory 304, a high density storage device 308, a keyboard 306, a display 310 and a mouse 312. In addition, there is a flash or floppy disk drive 314 and a CD-ROM drive 316 for entry of data and software, including software embodying the present invention, into the system on removable storage. An example of such a computer can be a Dell personal computer operating on Microsoft Windows operating system of the Microsoft Corporation. Also, in this example, there is an internet browser capable of running software programs—i.e. Google Chrome, e.g. Google Corporation, Internet Explorer, e.g., Microsoft Corporation

The various method embodiments of the invention will be generally administered by a computer performing a series of program instructions for carrying out the steps of the method, assuming all required data for processing is accessible to the computer. The series of program instructions may be embodied in a computer program product consisting of media storing the program instructions. As will be readily apparent to those skilled in the art, the present invention can be realized in hardware, software, or a combination of the two. Any kind of computer or server system(s) or any other apparatus adapted for carrying out the methods described herein is viable. A typical combination of hardware and software could be a general-purpose computer system with a computer program that, when loaded and executed, carries out the method, and variations on the method as described herein. Alternatively, a specific use computer, containing specialized hardware for carrying out one or more of the functional tasks of the invention, can be utilized.

Any combination of one or more computer usable or computer readable medium(s) may be utilized. The computer—usable or readable—medium may be, for example but not limited to, an electronic, magnetic, optical, electromagnetic, infrared, or semiconductor system, apparatus, device, or propagation medium. More specific examples of the computer readable medium would include the following: an electrical connection having one or more wires, a hard disk, a random access memory (RAM), a read-only memory (ROM), an erasable programmable read-only memory (EPROM) or Flash memory), an optical fiber, an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then complied, or otherwise processed in a suitable manner, if necessary, and then stored in the memory of a computer. In the context of this document, a computer usable or computer readable medium may be any medium that can contain, store, communicate, propagate, or transport the program for use by or in connection with the instruction execution system. The computer usable medium may include a propagated data signal with the computer usable program code embodied therewith, either in baseband or as part of a carrier wave, The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Javascript, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider).

The present invention is described above with reference to flow chart illustrations of methods, apparatus (systems) and computer program products according to embodiments of the invention. It will be understood that each block of the flow chart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart or blocks.

These computer program instructions may also be stored in a computer-readable medium that can direct a computer or other programmable data processing apparatus to function in a particular manner, such that the instructions stored in the computer readable medium produce an article of manufacture including instructions means which implement the function/act specified in the flowchart and/or blocks.

The computer program instruction may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions or acts specified in the flowchart.

The flowchart in the Figures illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

Although a few examples of the present invention have been shown and described, it would be appreciated by those skilled in the art that changes might be made in these embodiments without departing from the principles and spirit of the invention, the scope of which is defined in the claims and their equivalents.

What is claimed is:

1. A method including at least one processor coupled to a computing device and linked to a plurality of databases on which records are stored for contacting a medical professional by a user of the computing device comprising the steps of:
activating a service software program by operating an icon on the computing device to perform a function of locating a medical professional;
searching for the medical professional; and
providing video consults by telemedicine by establishing
communication between said medical professional and said user of the computing device upon locating said medical professional.

2. The method of claim 1 wherein said medical professional is a medical doctor.

3. The method of claim 2 wherein said medical doctor is known to the user of the computing device.

4. The method of claim 2 wherein said medical doctor is not known to the user of the computing device.

5. The method of claim 2 wherein said medical doctor transmits information relating the health of the user of the computing device.

6. The method of claim 5 wherein said information transmitted by the medical doctor to the user of the computing device is received orally.

7. The method of claim 5 wherein said information transmitted by the medical doctor to the user of the computing device is receiver in printed form.

8. The method of claim 1 wherein said user can view and interact with his/her own personal health record.

9. A system including at least one processor coupled to a computing device and linked to a plurality of databases on which records are stored for contacting a medical professional by a user of the computing device comprising the steps of:
activating a service software program by operating an icon on the computing device to perform a function of locating a medical professional;
searching for the medical professional; and
providing video consults by telemedicine by establishing
communication between said medical professional and said user of the computing device upon locating said medical professional.

10. The system of claim 9 wherein said medical professional is a medical doctor.

11. The system of claim 10 wherein said medical doctor is known to the user of the computing device.

12. The system of claim 10 wherein said medical doctor is not known to the user of the computing device.

13. The system of claim 10 wherein said medical doctor transmits information relating the health of the user of the computing device.

14. The system of claim 13 wherein said information transmitted by the medical doctor to the user of the computing device is received orally or in printed form.

15. The system of claim 9 wherein said user can view and interact with his/her own personal health record.

16. A computer program product for use with a computer, the computer program product including a computer readable medium having recorded thereon a computer program or program code for causing the computer to perform a method for storing and retrieving data, the method comprising:
activating a service software program by operating an icon on the computing device to perform a function of locating a medical professional;
searching for the medical professional;
providing video consults by telemedicine by establishing
communication between said medical professional and said user of the computing device upon locating said medical professional and said user can view and interact with his/her own personal health record.

17. The computer program product of claim 16 wherein said medical professional is a medical doctor.

18. The computer program product of claim 10 wherein said medical doctor is known to the user of the computing device.

19. The computer program product of claim 2 wherein said medical doctor is not known to the user of the computing device.

20. The computer program product of claim 17 wherein said medical doctor transmits information relating the health of the user of the computing device said information transmitted by the medical doctor to the user of the computing device is received orally or in printed form.
